(19) United States
(12) Patent Application Publication
(10) Pub. No.: US 2015/0019263 A1
(43) Pub. Date: Jan. 15, 2015

(54) ESTIMATED REPLACEMENT COST PROCESS

(71) Applicant: STATE FARM MUTUAL AUTOMOBILE INSURANCE COMPANY, Bloomington, IL (US)

(72) Inventors: Timothy Kiper, Normal, IL (US); Eric Staniak, Tacoma, WA (US); Matthew Cuttell, Bloomington, IL (US); Josh Schwartz, Bloomington, IL (US); Amy Engelhorn, Normal, IL (US); Jennifer Huffman, Bloomington, IL (US); Rhonda Benter, Le Roy, IL (US); Amy Schmidt, Bloomington, IL (US); Stacy Whitmer, Bloomington, IL (US); Matt J. Schroeder, Bloomington, IL (US); Kathryn E. Knarr, Bloomington, IL (US)

(21) Appl. No.: 13/940,679

(22) Filed: Jul. 12, 2013

(51) Int. Cl. G06Q 40/08

(52) U.S. Cl. CPC G06Q 40/08
USPC 705/4

(57) ABSTRACT

A server integrates cost estimates in a insurance price quote process. After receiving an identification of an insurable asset in response to the one or more questions, the server receives, via the computer network, an indication of a customer choice to launch a cost estimation interface on an end user device. The cost estimation interface is used to generate a cost estimate via communication with a cost estimation server. The server receives a cost estimate from the cost estimation server, the cost estimate being generated based on customer interaction with the cost estimation interface. Also, the server causes the cost estimate and quote process information to be displayed to the customer on the end user device.

### TECHNICAL FIELD

The present disclosure generally relates to insurance price quotes and, more particularly, to processes for obtaining insurance price quotes.

### BACKGROUND

The process of obtaining an insurance price quote, such as a homeowner's insurance price quote, often involves a cost estimate. In many cases, customers must provide a replacement cost estimate for an insurable asset, such as a house, to complete an insurance application and obtain an insurance price quote. However, many homeowners are unaware of differences between replacement costs and other cost estimates, such as market value, and, even if they are aware of differences, they may not know how to obtain or generate the appropriate estimate.

As a result, many homeowners leave applications incomplete based on confusion regarding cost estimates or difficulty in obtaining appropriate information. Further, customers often need direct aid from an insurance agent to complete an insurance application. Such direct aid, via phone or in-person consultations, for example, prolongs the time to complete the application and often prevents a customer from completing an application, from start to finish, in one price quote “session.”

### SUMMARY

In one embodiment, a computer-implemented method for integrating cost estimates in a insurance price quote process comprises causing one or more questions to be displayed to a customer on an end user device, wherein the one or more questions relate to identifying an insurable asset. Further the computer-implemented method includes receiving, via the computer network, an identification of an insurable asset in response to the one or more questions, causing quote process information to be displayed to the customer on the end user device, wherein the quote process information relates to cost estimation, and receiving, via the computer network, an indication of a customer choice to launch a cost estimation interface on the end user device, wherein the cost estimation interface is used to generate a cost estimate via communication with a cost estimation server. Still further, the method comprises querying, via one or more processors a database containing a plurality of customer information to retrieve information relating to the insurable asset, when the plurality of customer information includes information relating to the insurable asset, sending, via the computer network, the information relating to the insurable asset to the cost estimation server, and causing the cost estimation interface to be displayed to the customer on the end user device. Also, the method comprises receiving a cost estimate from the cost estimation server, the cost estimate being generated based on customer interaction with the cost estimation interface and causing the cost estimate and further quote process information to be displayed to the customer on the end user device.

According to another embodiment, a computer device for integrating cost estimates in an insurance price quote process comprises one or more processors and one or more memories coupled to the one or more processors, wherein the one or more memories include computer executable instructions stored therein that, when executed by the one or more processors, cause the one or more processors to cause one or more questions to be displayed to a customer on an end user device, wherein the one or more questions relate to identifying an insurable asset receive, via the computer network, an identification of an insurable asset in response to the one or more questions. Further, the one or more processors cause quote process information to be displayed to the customer on the end user device, wherein the quote process information relates to cost estimation, receive, via the computer network, an indication of a customer choice to launch a cost estimation interface on the end user device, wherein the cost estimation interface is used to generate a cost estimate via communication with a cost estimation server, and query, via one or more processors a database containing a plurality of customer information to retrieve information relating to the insurable asset. When the plurality of customer information includes information relating to the insurable asset, the one or more processors send, via the computer network, the information relating to the insurable asset to the cost estimation server. Still further, the one or more processors cause the cost estimation interface to be displayed to the customer on the end user device, receive a cost estimate from the cost estimation server, the cost estimate being generated based on customer interaction with the cost estimation interface, and cause the cost estimate and further quote process information to be displayed to the customer on the end user device.

According to yet another embodiment, a computer readable storage medium comprises non-transitory computer readable instructions stored thereon for integrating cost estimates in an insurance price quote process, the instructions, when executed on one or more processors, cause the one or more processors to cause one or more questions to be displayed to a customer on an end user device, wherein the one or more questions relate to identifying an insurable asset receive, via the computer network, an identification of an insurable asset in response to the one or more questions. Further, the one or more processors cause quote process information to be displayed to the customer on the end user device, wherein the quote process information relates to cost estimation, receive, via the computer network, an indication of a customer choice to launch a cost estimation interface on the end user device, wherein the cost estimation interface is used to generate a cost estimate via communication with a cost estimation server, and query, via one or more processors a database containing a plurality of customer information to retrieve information relating to the insurable asset. When the plurality of customer information includes information relating to the insurable asset, the one or more processors send, via the computer network, the information relating to the insurable asset to the cost estimation server. Still further, the one or more processors cause the cost estimation interface to be displayed to the customer on the end user device, receive a cost estimate from the cost estimation server, the cost estimate being generated based on customer interaction with the cost estimation interface, and cause the cost estimate and further quote process information to be displayed to the customer on the end user device.

### BRIEF DESCRIPTION OF THE DRAWINGS

FIG. 1 illustrates an example computing system capable of integrating cost estimates in an insurance price quote process.

FIG. 2 illustrates an example price quote server that develops insurance price quote content.

FIG. 3 is a flow diagram of an example method for integrating cost estimation in an insurance price quote process.

FIG. 4 illustrates an example set of initial questions for a customer.

FIG. 5 is an example web page with educational content related to cost estimation.

FIGS. 6A-6C illustrate example educational content for display on a mobile device.

FIG. 7 illustrates an example web page interface in which a customer may input a professional cost estimate.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

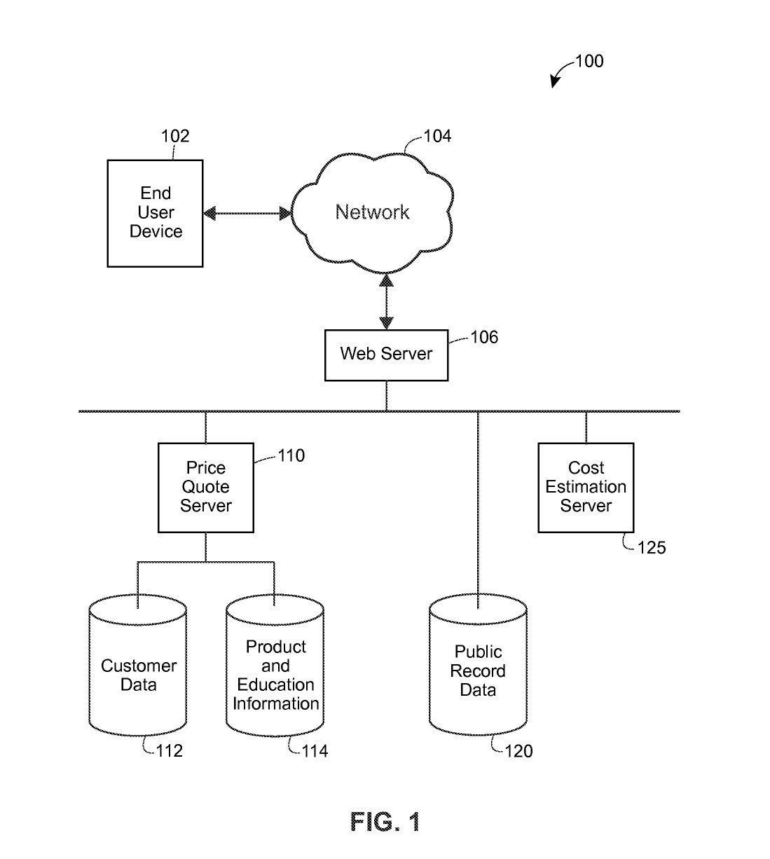

FIG. 1 illustrates an example computing system 100 capable of integrating cost estimates in an insurance price quote process. The price quote process may be a price quote process for a new purchase of a homeowners insurance, commercial property insurance, renters insurance, etc. policy or a price quote for modifying a currently existing insurance policy (e.g. with a new addition to a home or commercial property), for example. A cost estimate may be a replacement, market value, or other cost estimate used to develop an appropriate price quote for purchasing or modifying an insurance policy for a residential or commercial property, for example.

An end user device 102 is communicatively coupled, via one or more wired or wireless interfaces, to a network 104 and web server 106. The end user device may include any suitable computing device such as a personal computer, smartphone, tablet computer, etc. The network 104 may be a proprietary network, a secure public internet, a virtual private network or some other type of network, such as dedicated access lines, plain ordinary telephone lines, satellite links, combinations of these, etc. Where the network 104 comprises the Internet, data communications may take place over the network 104 via an Internet communication protocol.

The web server 106 may be implemented in one of several known configurations via one or more servers configured to process web-based traffic received via the network 104 and may include load balancing, edge caching, proxy services, authentication services, etc.

In an implementation, the end user device 102 is capable of executing a graphical interface (GUI) for a insurance product price quote process within a web browser application, such as Apple's Safari®, Google Android™ mobile web browser, Microsoft Internet Explorer®, etc. The web browser application may be implemented as a series of machine-readable instructions for receiving, interpreting, and displaying web page information from the web server 106 while also receiving inputs from the user. Further, those skilled in the art will recognize that the present system can be used in a dedicated application in addition to a web browser.

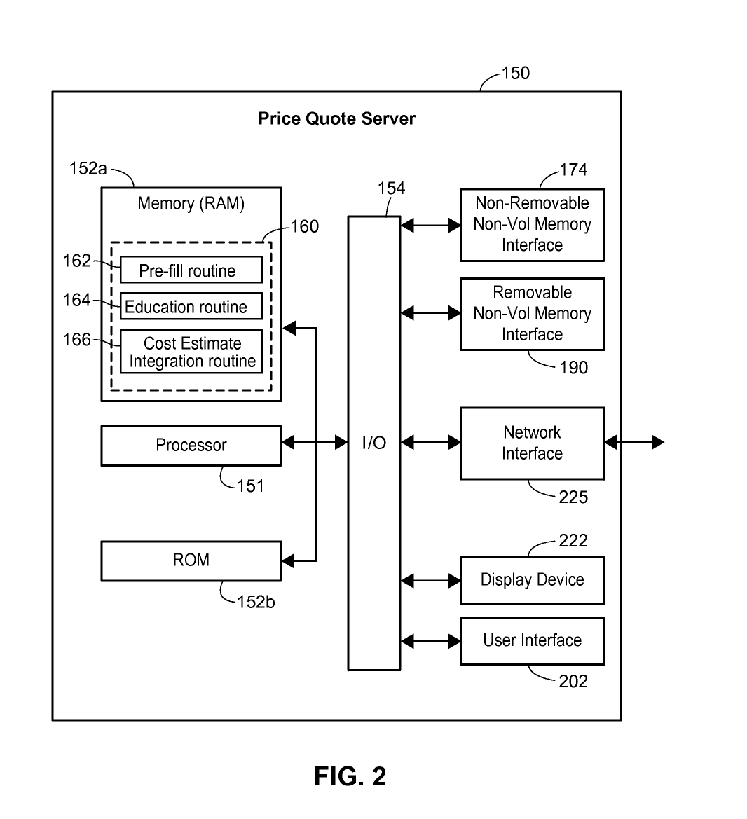

A price quote server 110 may include a number of software applications responsible for generating price quote process content to be included in the web pages sent from the web server 106 to the end user device 102. For example, the price quote server 110 may generate forms, educational information, cost estimate information, etc., as discussed below, to be included in the web pages sent to the end user device 102. The details of the price quote server are discussed in more detail with reference with FIG. 2.

In some implementations, the price quote server 110 is operatively connected to a customer database 112 and a product and education database 114. It should be noted that, while not shown, additional databases may be linked to the price quote server 110 in a known manner. The customer database 112 is adapted to store data related to current and prior insurance customers, in an implementation. For example, the customer database 112 may store structure information, address information, etc. for currently and previously insured assets. The data stored in the customer database may be data collected by insurance agents, data entered into web-based insurance applications by customers, etc., for example. The product and education database 114 is adapted to store data related to current and prior insurance products offered for sale and educational materials (e.g. videos, articles, suggestions, etc.) related to insurance products, price quote processes, etc., in an implementation.

In some implementations, the price quote server 110 is further communicatively coupled to a public record database 120. The public record database 120 may be a publicly accessible (i.e. not considered confidential) database adapted to store documents or information. For example, the public record database 120 may store certificate information (birth, death, etc.), adoption records, and property records. In particular, property records included in the public record database 120 may include parcel size, square footage, number of stories, foundation type, construction type, lot slope, etc. information regarding physical structures in a geographic area. Although one public record database 120 is illustrated in FIG. 1, the price quote server 110 may be connected to any number of supplementary data sources, such as other public record databases, open content or open source databases (e.g. those containing “tagged” photographs of geographic locations), or databases operated by third party companies, for example.

A cost estimation server 125 may include a number of software applications responsible for generating cost estimation content to be embedded within or launched from the price quote process web pages sent from the web server 106 to the end user device 102. For example, the cost estimation server 125 may generate forms, cost estimate calculations, etc., as discussed below, to be included in the insurance price quote process web pages sent to the end user device 102. In some embodiments, the cost estimation server 125 is operated by a third party (i.e. a party other than the operator of price quote server 110) that provides a cost estimation service, such as calculations of replacements costs, market values, etc.

FIG. 2 illustrates an example price quote server 150 that may provide integrated cost estimation in an insurance price quote process. The price quote server 150 may be implemented as the price quote server 110 in the example computing system 100, for example. The price quote server 150 may include a processing unit, 151, a system memory, 152a and 152b, and a system bus 154 that couples various system components including the system memory 152 to the processing unit 151. The system bus 154 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The price quote server 150 may include an assortment of computer-readable media. Computer-readable media may be any media that may be accessed by the price quote server 150. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory may include storage media in the form of volatile and/or non-volatile memory such as ROM 152a and RAM 152b. A basic input/output system (BIOS), containing algorithms to transfer information between components within the computer 150, may be stored in ROM 152b. Data or program modules that are immediately accessible or are presently in use by the processing unit 151 may be stored in RAM 152a. Data normally stored in RAM 152a while the price quote server 150 is in operation may include an operating system, application programs, program modules, and program data. In particular, the RAM 152a may store a price quote application program 160 including a pre-fill routine 162, education routine 164, and cost estimate integration routine 166, for example.

The price quote server 150 may also include other storage media such as a hard disk drive that may read from or write to non-removable, non-volatile magnetic media, a magnetic disk drive that reads from or writes to a removable, non-volatile magnetic disk, and an optical disk drive that reads from or writes to a removable, nonvolatile optical disk. Other storage media that may be used includes magnetic tape cassettes, flash memory cards, digital versatile disks, digital video tape, solid state RAM, and solid state ROM. The hard disk drive may be connected to the system bus 154 through a non-removable memory interface such as interface 174. A magnetic disk drive and optical disk drive may be connected to the system bus 154 by a removable memory interface, such as interface 190.

A user may interact with the price quote server 150 through input devices such as a keyboard or a pointing device (i.e., a mouse). A user input interface 202 may be coupled to the system bus 154 to allow the input devices to communicate with the processing unit 151. A display device such as a monitor 222 may also be connected to the system bus 154 via a video interface (not shown).

The price quote server 150 may operate in a networked environment using logical connections to one or more remote computing devices, such as end user device 102, web server 106, or cost estimation server 125, for example. The remote computing device may be a personal computer (PC), a server, a router, or other common network node. The remote computing device typically includes many or all of the previously-described elements regarding the price quote server 150, even though such elements are not illustrated in the remote computing devices of FIG. 1. Logical connections between the price quote server 150 and one or more remote computing devices may include a wide area network (WAN). A typical WAN is the Internet. When used in a WAN, the price quote server 150 may include a modem or other means for establishing communications over the WAN. The modem may be connected to the system bus 154 via the network interface 225, or other mechanism. In a networked environment, program modules depicted relative to the price quote server 150, may be stored in the remote memory storage device. As may be appreciated, other means of establishing a communications link between the computer 150 and a remote computing device may be used.

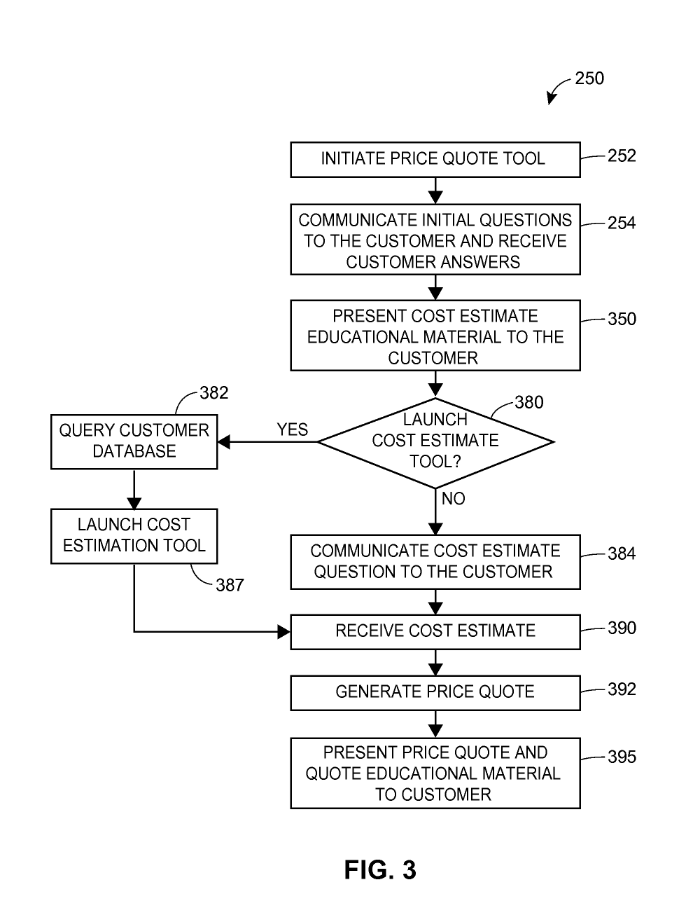

FIG. 3 is a flowchart of a method, routine or process 250 for integrating cost estimation in an insurance price quote process. The method 250 may be performed on one or more computers, such as the price quote server 110 illustrated in FIG. 1. Elements of the example system 100 and example price quote server 150 will be used in the description of method 250, but it is understood that any suitable computing system or server may implement the method 250.

A customer on a company web page or using a dedicated application for purchasing products or services from the company may make a selection, via an end user device, indicative of a decision to receive a quote for a particular insurance product. Homeowner's insurance products will be used in examples throughout the current description, but exemplary products that may also require cost estimates may include auto insurance, renter insurance, condo insurance, vehicle loans, motorcycle insurance, life insurance, etc.

In response to the customer's selection, an insurance price quote process begins (block 252) and the customer is presented with a set of initial questions (block 254). The questions may relate to information about the product used by the price quote server in identifying an insurable asset, such as a house. Exemplary questions may include questions related to customer names, customer ages, addresses, cities of residence, zip codes, etc. The questions may relate to identifying both the customer(s) and insurable asset, in an implementation. When the customer has answered one or more of the questions they may select (e.g. click or tap) a continue button or make some other input indicating they are ready to continue with the price quote process.

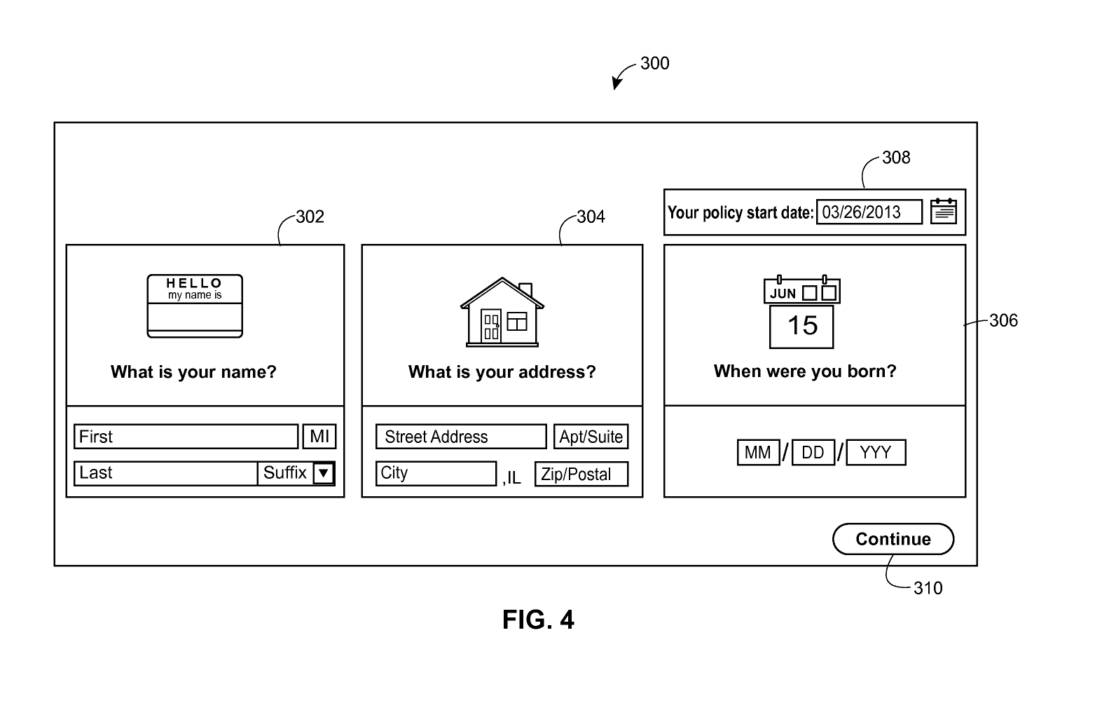

FIG. 4 shows an example screen 300 including a set of initial questions that may be presented to the customer at block 254. The screen 300 includes a section 302 of questions related to indentifying the customer, a section 304 of questions related to the location of a home, a question 306 related to date of birth, and a question 308 related to the desired policy start date. The customer may select a continue button 310 to proceed with the price quote process.

In some embodiments, one or more of the set of initial questions may be required to continue the price quote process. For example, the section 302 and the section 304 may include questions that are required questions, and, if the sections 302 and 304 are not fully completed by the customer (e.g. if there is not customer entered information inside the fields of the sections 302 and 304), the continue button 310 may not be active or selectable. In some embodiments, required questions are highlighted (e.g. with colors or symbols) when the customer clicks or taps the continue button 310 without answering the required questions.

Returning to FIG. 3, the price quote server receives the input indicating that the customer is ready to submit the answers to the questions, and, upon receiving the input, the answers to the questions are transmitted to the price quote server (block 254). Next (block 350), the price quote server presents the customer with educational material related to cost estimates, in an embodiment. The price quote server 150 may retrieve appropriate educational material from a database, such as product and education information database 114, by executing an education routine, such as education routine 164, for example. In some embodiments, the educational material may include agent communication options, such as click-to-call or click-to-chat options, allowing the customer to receive additional application assistance.

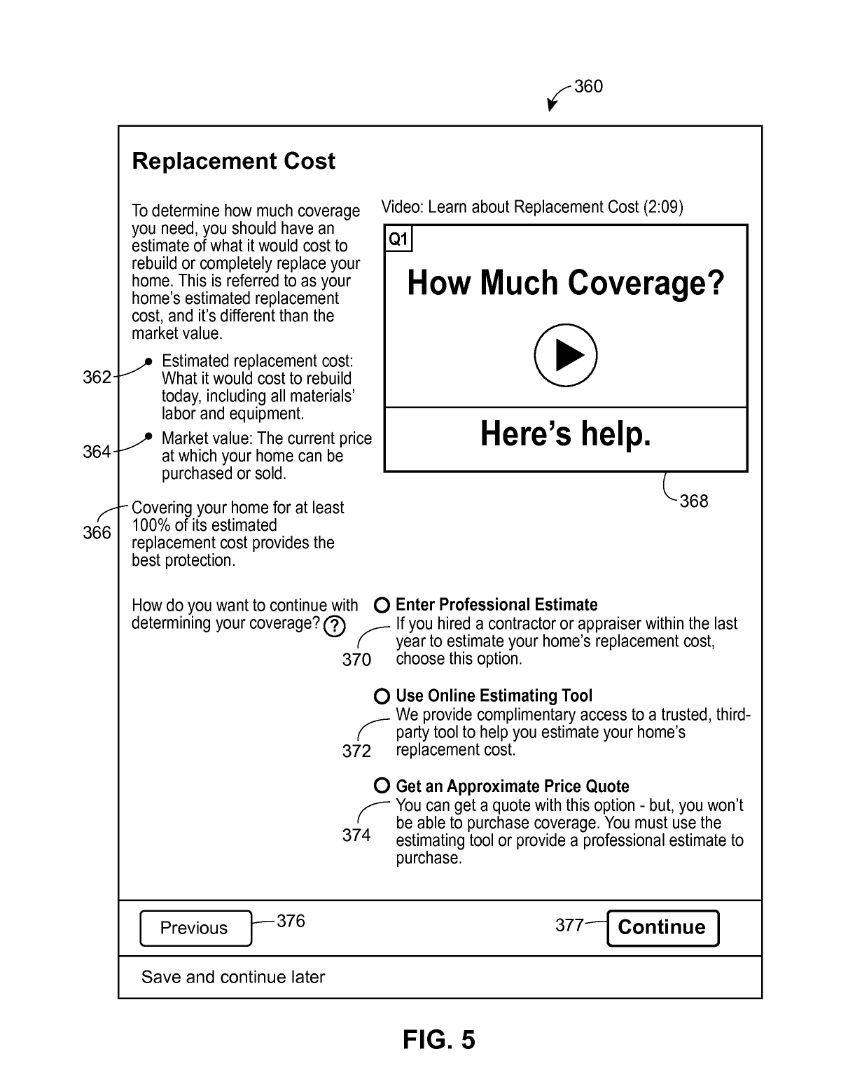

FIG. 5 is an example web page 360 including educational material that may be presented to the customer upon completion of the initial set of questions (block 350 of FIG. 4). The example web page 360 may be presented via a web browser application executed on an end user device, such as a desktop, laptop, or tablet computer, for example. The material included on the web page 360 relates to educating the customer on the difference between replacement cost and market values. To this end, the web page includes a bulleted list of definitions with an estimated replacement cost definition 362 and a market value definition 364, a recommendation 366 for an appropriate amount of insurance coverage, and an embedded educational video that may be launched via the embedded video icon 368.

Further, example web page 360 includes interactive features allowing the customer to choose how the customer wishes to continue the price quote process, in an implementation. For example, the web page 360 may include radio button 370, 372, and 374. The customer may select: (i) radio button 370 to enter a known cost estimate; (ii) radio button 372 to use an online cost estimate tool to develop a cost estimate; or (iii) radio button 374 to answer a series of questions and obtain an approximate price quote. The web page 360 may also include a previous button to take the customer back to the initial set of questions.

Upon selection of a continue button 377, or other suitable icon or interface, the price quote server 150 determines if the customer has selected to use an online cost estimate tool (block 380), in an implementation. The price quote server 150 may determine if the customer has selected radio button 372, for example. If the customer has selected to use (e.g. launch) an online cost estimate tool, the flow continues to block 382, but if the customer has selected another option (e.g. radio button 370 or 374), the flow continues to block 384.

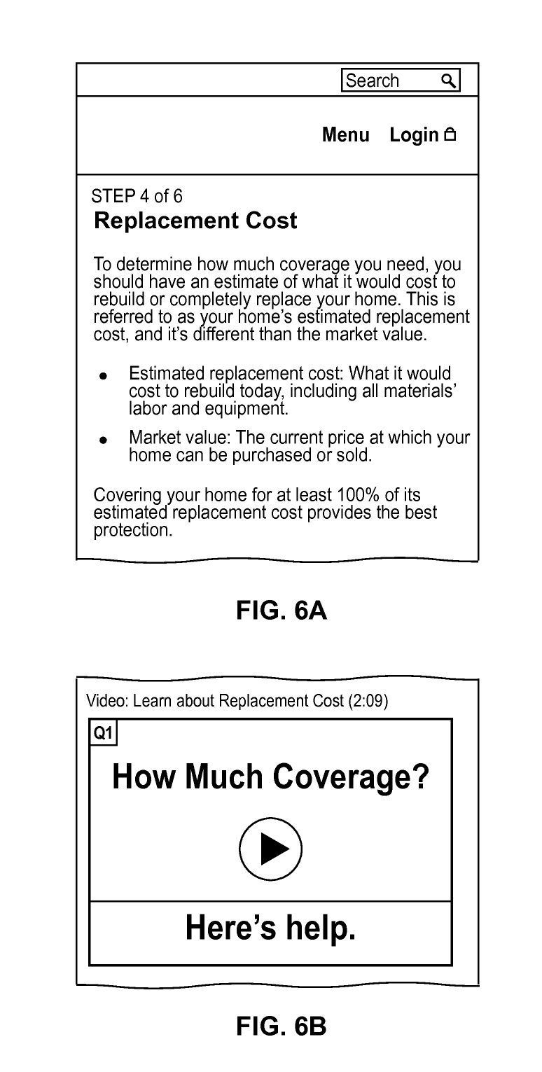

In some implementations, educational material may be presented to the customer in a format appropriate for specific end user devices. For example, web pages appropriate for display on a desktop computer monitor may not be ideal (e.g. efficient or visually appealing) for display on a smartphone. FIGS. 6A-6C illustrate example educational material for display on a mobile device, such a smart phone, tablet computer, or personal digital assistant (PDA). FIG. 6A illustrates a portion of educational material explaining differences between types of cost estimates. In some embodiments, a customer may scroll (e.g. with a trackball, finger motion, or tap) to view more educational material. FIG. 6B and FIG. 6C illustrate further educational material displayed upon customer scrolling from the material displayed in FIG. 6A. Further, FIG. 6C illustrates customer interactive features such as customer choice radio buttons and continue and previous buttons.

The price quote server 150 may query a customer database, such as customer database 112, to locate any previously stored information related to the insurable asset (block 382). For example, the customer database 112 may contain information related to a house identified at block 254, where the information was recorded in connection with a previously active (i.e. purchased and maintained) insurance policy on the house. The information may include the year the house was built, square footage, previous damage to the house, etc., and the price quote server 150 may query the database by home address, GPS coordinates, etc., for example.

The price quote server 150 transfers the answers to the initial questions entered at block 254 and information from the customer database retrieved at block 382 to a cost estimation server and launches an associated cost estimation tool (block 387), in an implementation. The cost estimation tool, operated by a third party server, may be launched from within the price quote tool to assist the customer by developing an accurate cost estimation, for example. The launching of the cost estimation tool may include opening a web browser with a link to web page content generated by a cost estimation server, such as cost estimation server 125, in an implementation. The web page content for the cost estimation tool may include questions or forms required to calculate an fairly accurate replacement cost estimate, such as questions related to roof type, year the house was built, home upgrades, etc., for example.

In an implementation, the price quote server 150 may store a routine, such as pre-fill routine 162, to pre-fill one or more questions generated by the cost estimation tool. For example, the pre-fill routine 162 may automatically answer some of the questions displayed by the cost estimation tool based on information in the customer database 112 or public record database 120. In a scenario, the customer may view the pre-filled (i.e. automatically generated) answers and modify the pre-filled answers with up-to-date information.

According to some implementations, a price quote server may communicate information about a home, retrieved from an insurance database, to a server, such as the cost estimation server 125, for pre-filling customer questions. Further, the server may retrieve information about a home from a public records, or other supplementary, database, such as public record database 120, to pre-fill customer questions, in the implementations. For example, the price quote server 110 may communicate previous home damage to the cost estimation server 125, and the cost estimation server 125 may retrieve a year in which the home was built from the public records database 120. The price quote server 150 may, in one implementation, query a customer database regardless of the choice of the customer to launch, or not launch, a cost estimation tool. For example the price quote server 150 may retrieve structure information (e.g. year, stories, square footage, etc.) from a public or internal database regardless of the type and/or availability of a cost estimate, where such structure information is necessary for or relevant to other portions of the price quote process.

In some scenarios, the information retrieved from a customer database, information retrieved from a public records database, and information entered by a customer is inconsistent. For example, a customer database may indicate that a home has a pool, based on information from previously purchased insurance products on the home, but a current customer may have removed or filled in the pool for liability reasons. In such an example case, the information entered by the customer and information from public records may be contradictory. The price quote server 150 may, in some implementations, dictate a prioritization of information. For example, the price quote server 150 may provide instructions (e.g. a prioritization list) for the cost estimation server indicating that customer-entered information takes priority over information from customer or public record databases. In this way, accurate and up-to-date information may be gathered to develop cost estimates within an insurance price quote application.

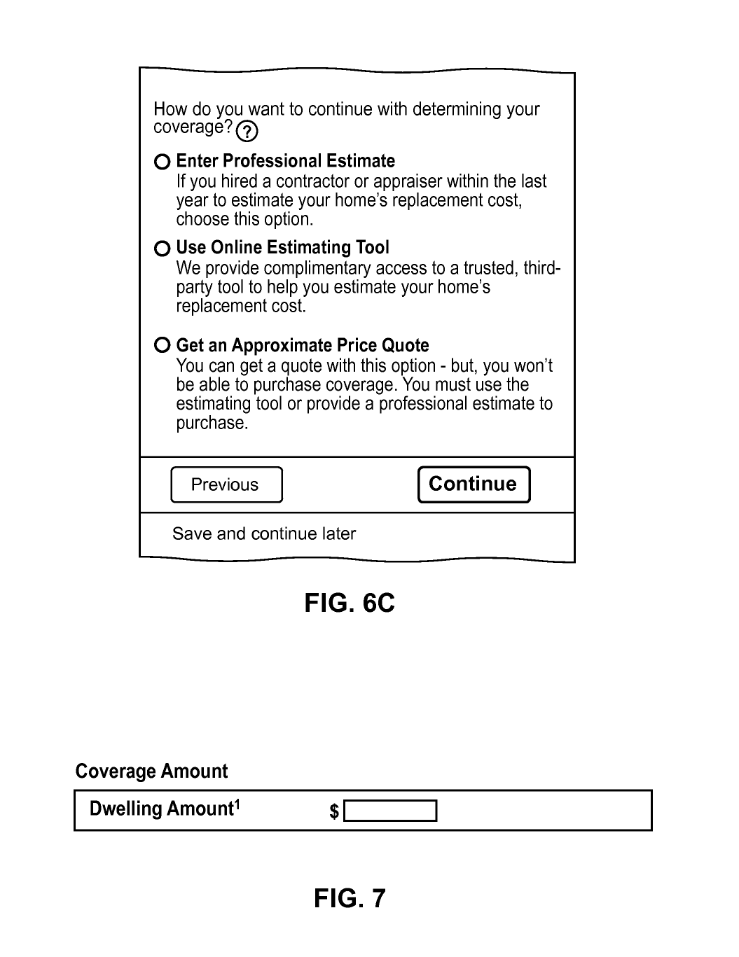

If, at block 380, the customer does not choose to launch a cost estimation tool, the price quote server 150 may communicate one or more questions to the customer related to entering a professional cost estimate (block 384), in an embodiment. For example, a customer may be ready to enter a professional cost estimate upon entering the price quote process. In such an embodiment, the price quote server 150 may present the customer with a text box, or any other suitable interface, for entering a professional cost estimate. For example, FIG. 7 illustrates a text box interface in which a customer may manually enter a professional cost estimate, such as a replacement cost estimate. Further, the price quote server 150 may require the upload of documentation related to the professional price quote, in an implementation.

In some implementations, the customer may be presented to more than one cost estimate option, in addition to a choice to launch the cost estimation tool. For example, the web page 360 presents the customer with three choices via the radio button 370, 372, and 374. Moreover, in some implementations, the customer may have the choice to abort, or otherwise redirect the price quote tool. For example, upon selection of the radio button 374, a cost estimate may be guessed or even omitted from the price quote process to obtain an approximate price quote.

Returning to FIG. 3, the price quote server 150 receives a cost estimate, such as a replacement cost estimate (block 390). Then, based on the cost estimate, the price quote server 150 develops an insurance product price quote (block 392). For example, the insurance product price quote may be based on the cost estimate, answers to the initial questions (entered at block 254), information in a customer database, insurance product options selected by the customer, etc.

In some embodiments, the price quote server 150 may present the cost estimate, price quote, and additional educational material to the customer (block 395). The price quote server 150 may integrate the cost estimate into a summary of the insurance price quote and educational information related to the price quote (e.g. using cost estimate integration routine 166), for example. In this way, the customer may easily view all the relevant information used in the development of the insurance price quote.

1. A computer-implemented method for integrating cost estimates in an insurance price quote process, the method comprising:
causing, with one or more processors, one or more questions to be displayed to a customer on an end user device, wherein the one or more questions relate to identifying an insurable asset;
receiving, via the computer network, an identification of an insurable asset in response to the one or more questions;
causing, with the one or more processors, quote process information to be displayed to the customer on the end user device, wherein the quote process information relates to cost estimation;
receiving, via the computer network, an indication of a customer choice to launch a cost estimation interface on the end user device, wherein the cost estimation interface is used to generate a cost estimate via communication with a cost estimation server,
querying, via the one or more processors, a database containing a plurality of customer information to retrieve information relating to the insurable asset;
when the plurality of customer information includes information relating to the insurable asset, sending, via the computer network, the information relating to the insurable asset to the cost estimation server;
causing, with the one or more processors, the cost estimation interface to be displayed to the customer on the end user device;
receiving a cost estimate from the cost estimation server, the cost estimate being generated based on customer interaction with the cost estimation interface; and
causing, with the one or more processors, the cost estimate and further quote process information to be displayed to the customer on the end user device.

2. The computer-implemented method of claim 1, wherein the insurable asset is a residential structure.

3. The computer-implemented method of claim 2, wherein the identification of an insurable asset includes an indication of the address of the residential structure.

4. The computer implemented method of claim 2, wherein the plurality of cost estimation information includes at least one of physical characteristics of the residential structure or historical information related to the residential structure.

5. The computer implemented method of claim 1, wherein the insurable asset is a commercial property.

6. The computer-implemented method of claim 1, wherein generating the cost estimation comprises generating a replacement cost estimation.

7. The computer-implemented method of claim 1, wherein generating the cost estimation comprises generating a market value estimation.

8. The computer-implemented method of claim 1, wherein displaying the quote process information includes at least one of:
(i) displaying educational videos,
(ii) displaying information distinguishing various types of cost estimates,
(iii) displaying customer specific recommendations,
(iv) displaying insurable asset specific recommendations,
(v) displaying a selectable option to enter a professional cost estimate, or
(vi) displaying a selectable option to obtain an approximate price quote.

9. The computer-implemented method of claim 1, wherein the determining the answer to one or more of a set of questions is further based on at least one of public record data, open source or open content data, or third party data related to the insurable asset.

10. The computer-implemented method of claim 9, wherein the determining the answer to one or more of a set of questions comprises a prioritizing of at least some of the plurality of customer information, customer communicated information, public record data, open source or open content data, or third party data related to the insurable asset.

11. The computer-implemented method of claim 1, wherein the communicating quote process information to the customer via the computer network is triggered by at least one of:
(i) detecting customer progress in the process to obtain an insurance price quote, or
(ii) receiving a customer request for quote process information.

12. The computer-implemented method of claim 1, wherein the one or more questions relate to identifying an insurable asset and relate to identifying the customer.

13. A computer device for integrating cost estimates in an insurance price quote process, the computer device comprising:
one or more processors; and
one or more memories coupled to the one or more processors;
wherein the one or more memories include computer executable instructions stored therein that, when executed by the one or more processors, cause the one or more processors to:
cause one or more questions to be displayed to a customer on an end user device, wherein the one or more questions relate to identifying an insurable asset;
receive, via the computer network, an identification of an insurable asset in response to the one or more questions;
cause quote process information to be displayed to the customer on the end user device, wherein the quote process information relates to cost estimation;
receive, via the computer network, an indication of a customer choice to launch a cost estimation interface on the end user device, wherein the cost estimation interface is used to generate a cost estimate via communication with a cost estimation server,
query a database containing a plurality of customer information to retrieve information relating to the insurable asset;
when the plurality of customer information includes information relating to the insurable asset, send, via the computer network, the information relating to the insurable asset to the cost estimation server;
cause the cost estimation interface to be displayed to the customer on the end user device;
receive a cost estimate from the cost estimation server, the cost estimate being generated based on customer interaction with the cost estimation interface; and
cause the cost estimate and further quote process information to be displayed to the customer on the end user device.

14. The computer device of claim 13, wherein the insurable asset is a residential structure.

15. The computer device of claim 14, wherein the identification of an insurable asset includes an indication of the address of the residential structure.

16. The computer device of claim 14, wherein the plurality of cost estimation information includes at least one of physical characteristics of the residential structure or historical information related to the residential structure.

17. The computer device of claim 13, wherein displaying the quote process information includes at least one of:
(i) displaying educational videos,
(ii) displaying information distinguishing various types of cost estimates,
(iii) displaying customer specific recommendations, or
(iv) displaying insurable asset specific recommendations.

18. The computer device of claim 13, wherein the communicating quote process information to the customer via the computer network is triggered by at least one of:
(i) detecting customer progress in the process to obtain an insurance price quote, or
(ii) receiving a customer request for quote process information.

19. A computer readable storage medium comprising non-transitory computer readable instructions stored thereon for integrating cost estimates in an insurance price quote process, the instructions, when executed on one or more processors, cause the one or more processors to:
cause one or more questions to be displayed to a customer on an end user device, wherein the one or more questions relate to identifying an insurable asset;
receive, via the computer network, an identification of an insurable asset in response to the one or more questions;
cause quote process information to be displayed to the customer on the end user device, wherein the quote process information relates to cost estimation;
receive, via the computer network, an indication of a customer choice to launch a cost estimation interface on the end user device, wherein the cost estimation interface is used to generate a cost estimate via communication with a cost estimation server,
query a database containing a plurality of customer information to retrieve information relating to the insurable asset;
when the plurality of customer information includes information relating to the insurable asset, send, via the computer network, the information relating to the insurable asset to the cost estimation server;
cause the cost estimation interface to be displayed to the customer on the end user device;
receive a cost estimate from the cost estimation server, the cost estimate being generated based on customer interaction with the cost estimation interface; and
cause the cost estimate and further quote process information to be displayed to the customer on the end user device.

20. The computer readable storage medium of claim 19, wherein the insurable asset is a residential structure.

21. The computer readable storage medium of claim 19, wherein generating the cost estimation comprises generating a replacement cost estimation.
